(19) United States
(12) Patent Application Publication
(10) Pub. No.: US 2006/0233404 A1
(43) Pub. Date: Oct. 19, 2006

(54) Horn array emitter

(75) Inventors: James J. Croft, Poway, CA (US); Elwood G. Norris, Poway, CA (US)

Correspondence Address: THORPE NORTH & WESTERN, LLP., 8180 SOUTH 700 EAST, SUITE 200, SANDY, UT, 84070, US

(73) Assignee: American Technology Corporation.

(21) Appl. No.: 11/196,803

(22) Filed: Aug. 2, 2005

Related U.S. Application Data
(63) Continuation-in-part of application No. 09/819,301, filed on Mar. 27, 2001, now Pat. No. 6,925,187.
(60) Provisional application No. 60/192,778, filed on Mar. 28, 2000.

(51) Int. Cl. H04R 25/00

(52) U.S. Cl. 381/191

(57) ABSTRACT

A system and method is disclosed for a parametric emitter array with enhanced emitter-to-air acoustic coupling. The system comprises a plate support member having opposing first and second faces separated by an intermediate plate body. The plate body can have a plurality of conduits configured as an array of acoustic horns. Each horn can have a small throat opening at the first face and an intermediate horn section which diverges to a broad mouth opening at the second face. An emitter membrane can be positioned in direct contact with the first face and extending across the small throat openings. The emitter membrane can be biased by (i) applying tension to the emitter membrane extending across the throat openings, (ii) displacing the emitter membrane into a non-planar configuration, and (iii) capturing the emitter membrane at the first face using an adhesive substance. A variable electrical signal can be applied to the emitter membrane for propagation through the intermediate horn section and out the broad mouth opening at the second face.

### CROSS-REFERENCE TO RELATED APPLICATIONS AND CLAIM OF PRIORITY

This is a continuation-in-part of U.S. patent application Ser. No. 09/819,301 filed on Mar. 27, 2001 which claims priority of United States Provisional patent application Ser. No. 60/192,778 filed on Mar. 28, 2000.

### FIELD OF THE INVENTION

The present invention relates generally to ultrasonic emitters.

### BACKGROUND

A variety of emitter devices have been developed which propagate ultrasonic energy. These include piezoelectric transducers, electrostatic emitters, mechanical drivers, etc. A challenge with the use of such devices in air is to provide impedance matching methods to enhance the efficiency of power transfer to the ambient air. For example, the wave impedance of a piezoelectric material such as barium titanate exceeds the impedance of air by a factor of 105. This extreme impedance difference severely attenuates transmission of a propagated ultrasonic beam of energy into the air.

The use of acoustic horns as transformer devices is well known with respect to most sound systems for both audio and ultrasound frequencies. Extensive research has been done detailing preferred horn configurations for specific frequency ranges. Mathematical formulas are generally available to optimize the geometry of each application for a given frequency.

A publication by Fletcher and Thwaites entitled “Multi-horn Matching Plate for Ultrasonic Transducers” Ultrasonics 1992, Vol 30, No. 2, discloses the use of an array of acoustic horns formed in a plate as an acoustic transformer for ultrasonic transmission into air. Based on this disclosure, FIG. 1 shows a transducer aligned with a horn plate. A spacing gap between the emitter element and throats of the respective horns is illustrated and identified as a key element in optimizing the efficiency of the horn array for ultrasonic energy. By choosing a gap distance specifically selected for a given horn array, the publication suggests improvement of pressure gain in transducer output by 10 dB or better.

Despite enhancement of the effectiveness by this horn array system, there remain significant problems in impedance matching, particularly with ultrasonic emitters.

Many new applications of ultrasonic energy, including parametric speakers, are offering new opportunities which require high levels of efficiency in order to obtain a commercially acceptable audio output from ultrasonic emissions. Generally, these parametric applications depend on effective impedance matching to enable propagation of ultrasonic waves into the air as the nonlinear medium necessary for acoustic heterodyning.

### SUMMARY

A system and method is disclosed for a parametric emitter array with enhanced emitter-to-air acoustic coupling. The system comprises a plate support member having opposing first and second faces separated by an intermediate plate body. The plate body can have a plurality of conduits configured as an array of acoustic horns. Each horn can have a small throat opening at the first face and an intermediate horn section which diverges to a broad mouth opening at the second face. An emitter membrane can be positioned in direct contact with the first face and extending across the small throat openings. The emitter membrane can be biased by (i) applying tension to the membrane extending across the throat openings, (ii) displacing the membrane into a non-planar configuration, and (iii) capturing the emitter membrane at the first face using an adhesive substance. A variable electrical signal can be applied to the membrane for propagation through the intermediate horn section and out the broad mouth opening at the second face.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 depicts a prior art example of an emitter configuration utilizing an array of horn transformers for acoustic coupling with air;

FIG. 2 shows a perspective view of an integral emitter/horn array constructed in accordance with an embodiment of the present invention;

FIG. 3 is a detailed sectional view of the integral emitter and throat of the horn in accordance with an embodiment of the present invention;

FIGS. 4 through 6 graphically illustrate alternative embodiments demonstrating various methods of displacing the emitter membrane within the small throat opening in accordance with an embodiment of the present invention;

FIG. 7a shows an elevational view of an integral emitter/horn array having elongate impedance transformer strips in accordance with an embodiment of the present invention;

FIG. 7b shows an elevational view of the emitter/horn array of FIG. 9a in an exploded view in accordance with an embodiment of the invention;

FIG. 8 graphically illustrates an embodiment of a horn array as part of a parametric speaker system for generating audio frequencies from ultrasonic output;

FIG. 9 illustrates a flow chart depicting a method for developing a high efficiency acoustic coupling device for coupling parametric emitters to a surrounding air environment in accordance with an embodiment of the present invention; and

FIG. 10 illustrates a flow chart depicting a method for enhancing emitter-to-air acoustic coupling of a parametric array in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

A parametric emitter array 10 is illustrated in FIG. 2. It comprises a plate support member 11 having opposing first and second faces 13 and 12 separated by an intermediate plate body 14. The plate 11 is preferably a rigid material (metal, ceramic, polymer, etc), and may be either conductive or nonconductive, depending on the method of driving an emitter membrane 20 directly coupled to the first face 13. The thickness of the plate may vary, depending on the acoustic coupling properties required for specific frequency ranges and particular applications. Generally, the plate thickness will be within the range of 1 millimeter (mm) to 20 mm. The selection of acoustical, electrical and physical properties will be discussed hereafter.

The plate body includes a plurality of conduits configured as an array of acoustic horns 30. Each horn has a small throat opening 31 at the first face 13 and an intermediate horn section 32 which diverges to a broad mouth opening 33 at the second face 12. The degree of flair in the intermediate horn section, as well as the size of the respective small throat and broad mouth openings 31 and 33 may be configured in accordance with conventional design parameters. These parameters will be balanced and optimized, depending upon the degree of directionality desired, the bandwidth response selected and the gain and coupling efficiency intended. Detailed design considerations are therefore deemed unnecessary for enablement of the present disclosure. Representative dimensions illustrated in FIG. 2 are a 10 mm diameter for the mouth 33, 2 mm diameter for the throat opening, and 10 mm for length or thickness of the plate.

In the illustrated embodiment, the array of horns comprises conduits which are molded to a desired shape within the plate support member for acoustic coupling of ultrasonic frequencies to surrounding air. Appropriate techniques are well known within the injection molding industry for implementing these procedures. Alternatively, the array of horns may have conduits which are machined to the desired shape.

One embodiment of the plate support member comprises a circular plate as opposed to the rectangular shape illustrated in FIG. 2. Such a configuration offers an emitted sound column of more uniform nature because of the common radius of the resulting beam output. Dimensions of the plate support member may vary. However, the diameter the diameter of the plate support member is generally at least three inches. The configuration may be planar or curved. A concave configuration enables selection of a curvature radius to minimize phase misalignment for a listener location at a predetermined distance from the emitter array. This is accomplished by adjusting the radius of curvature of the emitting face so that the distances from each mouth opening are common at a given listener location. Numerous other variations will be apparent to those of ordinary skill in the art.

Many forms of acoustic emitters may be coupled directly to the opening 31 at the throat of the horn. Selection of a specific emitter will be a function of the intended use of the horn array. Generally these emitters fall within two classes. The first class of emitters comprises those which function as the primary source of mechanical movement for development of compression waves. This class, referred to as acoustic drivers, includes an emitter membrane which is mechanically or physically displaced to create periodic compression waves in a direct or active mode. Examples of the first class of drivers includes piezoelectric emitters, mechanical oscillators, and similar structures which displace in response to energy supplied directly to the membrane.

One example embodiment conceived as part of the present invention involves the use a film or flexible membrane. Various types of film may be used as an emitter film. The important criteria are that the film be capable of (i) deforming into arcuate emitter sections at the opening 31 locations, and (ii) responding to an applied electrical signal to constrict and extend in a manner that reproduces an acoustic output corresponding to the signal content. Although piezoelectric materials are the primary materials that supply these design elements, new polymers are being developed that are technically not piezoelectric in nature. Nevertheless, the polymers are electrically sensitive and mechanically responsive in a manner similar to the traditional piezoelectric compositions. Accordingly, it should be understood that reference to piezoelectric films in this application is intended to extend to any suitable film that is both electrically sensitive and mechanically responsive (ESMR) so that acoustic waves can be realized in the subject transducer.

One type of ESMR film is made of polyvinylidene difluoride (PVDF) material. This material has demonstrated surprising utility with respect to direct generation of ultrasonic emissions as will be discussed hereafter. Because PVDF material responds directly to voltage variations, ultrasonic emissions can be directly generated at the small throat opening in a highly controlled manner by applying a variable electrical signal at a frequency proportional to the desired sonic or ultrasonic emission frequency or combination of frequencies.

The second class of emitters is characterized by passive or indirect power transmission, rather than in an active or direct mode. Electrostatic and magnetostrictive emitters are representative of this group. Operation of these emitters requires an independent drive source such as a variable voltage back plate or some other driver which passively or indirectly displaces the emitter mounted at the throat opening 31. For example, an electrostatic membrane having a conductive film may be directly coupled at the small opening 31, and pinched or otherwise biased into a state of tension. Variable electronic signals operated at a sonic or ultrasonic frequency or combination of frequencies can be applied to a conductive back plate which is electrically insulated from the membrane film, thereby coupling the ultrasonic signal to the electrostatic membrane for generating the desired compression waves through the horn.

Both classes of emitters are positioned in direct contact with the first face 13 and extend across the small throat openings. This is somewhat counter to teachings of the prior art, which have required a displacement gap between the emitter and the small opening of the horn. The present inventors have discovered that by directly attaching the emitter at the first face 13, and in direct position at the throat of the horn, enables the horn to be a highly efficient ultrasonic emission source which couples surprisingly well with a surrounding air environment.

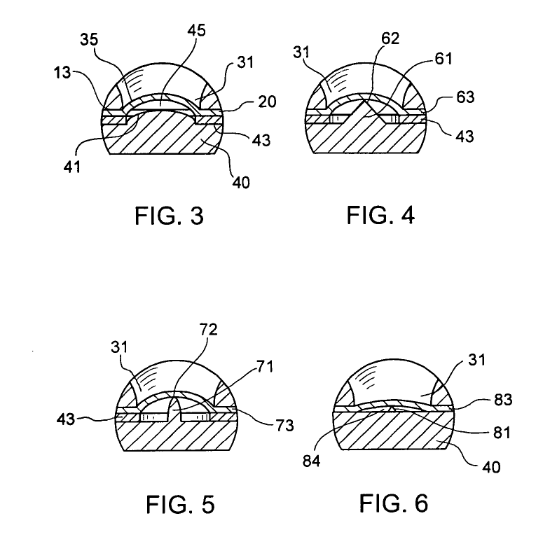

A biasing means is required for enabling the emitter membrane to properly function. This biasing means may be physically or inductively operative with respect to the emitter membrane. The biasing means is capable of (i) applying tension to the membrane extending across the throat openings and (ii) displacing the membrane into a non-planar configuration. This is represented in FIG. 3 et. seq. by the slightly deformed or displaced emitter membrane 35 which is projecting within the small throat opening 31. The emitter membrane is part of a continuous membrane 20 which is disposed across the first face 13 of the plate support member. For example, the deformed emitter membrane 35 may be a preformed dimple positioned within the continuous membrane 20 and in alignment with the small throat opening 31. The dimpled structure forms part of the biasing means as described above, and would be complemented with a tension force to place the emitter membrane in a biased position which permits vibrating motion consonant with a desired sonic or ultrasonic signal.

The ESMR film may be captured at the film contacting faces using an adhesive substance to provide a substantially permanent tension force to the film. The film may be deformed into a non-planar configuration prior to being captured. An electrically conducting adhesive can be used so that the film contacting face may also serve as an electrode to transfer a voltage applied to the support member to the ESMR film. When high levels of voltage are applied to an ESMR film, the film may generate heat that should be dissipated. Hence, there may be a preference that the adhesive be thermally conductive, so that the support member may also serve as a heat sink for the ESMR film. Finally, to ease the manufacturing process, and to improve the reliability of the transducer, there also may be a preference that the adhesive have a rapid cure time, facilitated when an accelerating or activating fluid is applied. When the adhesive material is applied to the film contacting face, it is important to apply the adhesive as uniformly as possible. Inconsistencies in the adhesives or film contacts may result in inconsistencies in the arcuate sections of the film, causing a lower Q, and unwanted distortion. A screen-printing technique may be used to uniformly apply the adhesive. It may be preferred that the thickness of the adhesive be less than ten thousandths of an inch.

The ESMR film can also be coupled to a back plate 40 using electrically conductive adhesive material. The backplate can be positioned behind the membrane and adjacent the small throat openings, and may also serve as part of the biasing means. For example, corresponding dimples 41 can be formed on the back plate in proper alignment to force the emitter membrane within the small throat openings 31. A spacer element 43 may be inserted between the back plate 40 and the emitter membrane 20 to displace the emitter portion 35 from contact with the back plate 40. This may be enhanced by the capture of a pocket of air 45 as a cushion which provides displacement space for the emitter membrane 35. Where ESMR film comprises the emitter membrane, vibration displacements activated by a variable voltage source can be of such small distances that the gap formed by the pocket of air 45 may be very small.

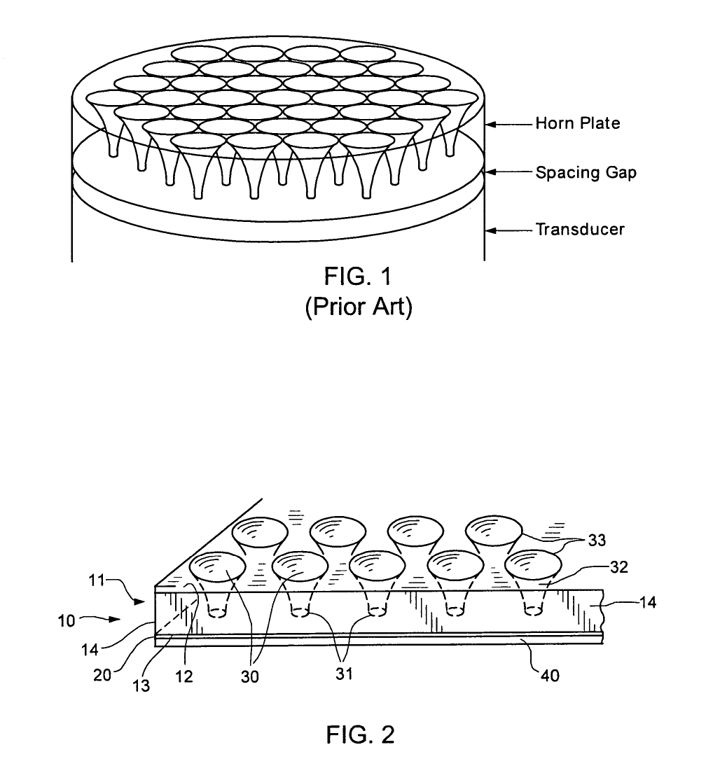

The spacer element 43 may also be viewed as structure for clamping the membrane in fixed position around the small throat opening such that vibrational energy is not transferred through the membrane to adjacent horns. This same function can be performed by the back plate in the absence of the spacer element. Isolation of each emitter element 35 is important for minimizing cross transmission of vibrations through the continuous membrane 20. The spacer and/or back plate can also act as a damping member to reduce vibrations carried through the plate support member 11 (FIG. 1). With each emitter membrane being supplied by a common voltage or energy source, and operating as a continuous membrane having uniform physical properties, the isolated emitter sections 35 can be tuned and electronically or mechanically activated to develop a uniform wave front with minimal distortion. The application of this emitter configuration with an array of horn-type acoustic transformers offers significant advantages over other emitter systems.

The back plate, as shown in FIG. 3, may also include protruding structure 41 aligned with each small throat opening as part of the biasing means. The protruding member operates to displace the emitter membrane slightly and/or to apply proper tension with sufficient displacement to allow activation as a sonic or ultrasonic generator. Again, where ESMR film is used, the displacement distance is so nominal that the protruding portion need not extend more than 3 mm. FIGS. 3-6 illustrate various geometric shapes that are useful to displace the emitter membrane into the desired non-planar configuration.

The protruding structure 41 shown in FIG. 3 comprises a convex bump having a size approximately equal to the small throat opening such that the bump projects within the throat of the horn. This configuration is very effective in isolating and developing uniform vibration response across the emitter section. The back plate includes means for developing a gap between the convex bump and the membrane to allow vibrational displacement of the membrane when activated with a sonic or ultrasonic frequency, thereby avoiding distorting contact with the convex bump. Typical dimensions of the convex bump include a radius of curvature of 10-30 mm and a height of 1-3 mm from the planar surface of the backplate.

An additional method for developing the required gap between the convex bump and the membrane comprises structure for supplying an electrostatic charge operable to repel the membrane from the bump during operation. This can be accomplished by establishing a baseline signal within the ESMR film which maintains a threshold tension, enabling the desired output signal to be applied for the generation of the sonic output in the emitter. It is possible to utilize a carrier signal for this biasing purpose, with sidebands providing the output signal. A similar biasing means can be developed with structure for supplying a magnetic force operable in a manner similar to the electrostatic embodiment to repel the membrane from the bump during operation.

As indicated above, a simple means for developing the required gap between the convex bump and the membrane may consist of a spacer ring positioned between the membrane and the back plate, with the bump being disposed in alignment with a central opening of the spacer ring. This spacer element is representative of numerous forms of mechanical means useful for displacing the emitter membrane from the backplate and bump. The thickness of the spacer will depend upon the range of frequency and amplitude of vibration of the emitter member. Typically, when operating within the ultrasonic range, spacer elements will vary in dimension from 1 to 3 mm. Numerous materials may be selected, balancing such factors as insulative properties, damping constants, expansion coefficients, and chemical/mechanical compatibility with the backplate and the support plate.

Other forms of mechanical means for developing the gap between the back plate and the membrane are represented in FIGS. 4 to 6. These include a protruding structure having an apex configuration in contact with a central portion of the membrane to physically displace the membrane from the back plate. As an example, FIG. 4 shows a conical structure 61 having an apex 62 in contact with a central portion of the membrane 63 to physically displace the membrane. A further embodiment shown in FIG. 5 comprises a pin structure 71 having an apex 72 in contact with a central portion of the membrane 73. These embodiments may be provided with a spacer 43 to develop the desired gap between the back plate and membrane. The various shapes are to be considered as representative of the general concept that the emitter membrane can be mechanically displaced to provide the biasing and necessary gap for operation within the inventive concept.

FIG. 6 illustrates the placement of the projecting element directly from the back plate without presence of a spacer for gap formation. Instead, a small projection 81 extends at a sufficient length to displace the membrane 83 away from the back plate 40 to provide space for vibration. With minimal displacements such as occur with higher ultrasonic frequencies, small gaps 84 on each side of the projection 81 are sufficient to enable operation of the emitter.

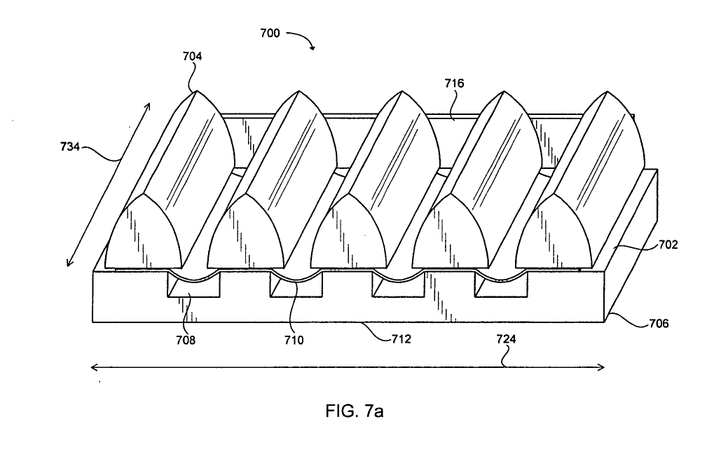

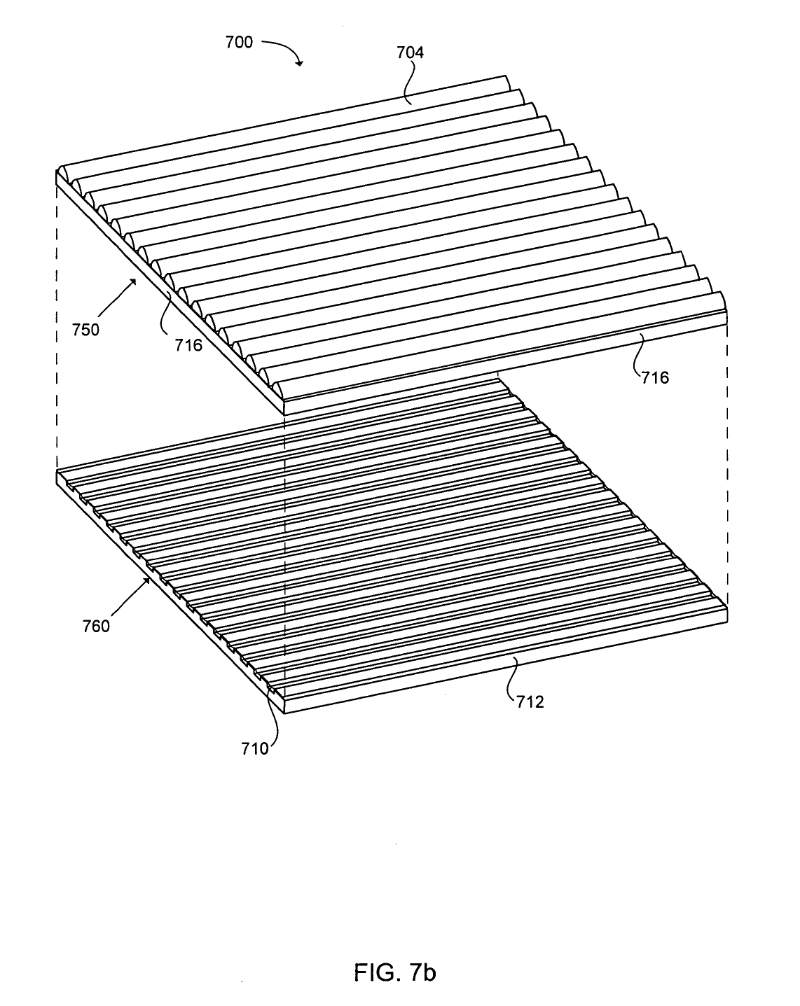

Another embodiment of a horn array emitter comprising a rectangular emitter 700 is shown in FIG. 7a. A plate support member 712 can have opposing first 702 and second 706 faces. The plate support emitter can have a first dimension 724 that is longer than a second dimension 734. The plate support emitter may be formed having a plurality of channels 708. In one embodiment, the channels can run a length of the plate. The plate support member can be a rigid material (metal, ceramic, polymer, etc), and may be either conductive or nonconductive. An emitter membrane 710 can be placed over the first face of the plate support member and channels. The emitter membrane can be an ESMR film. The emitter membrane can be coupled to the first face in such a way that the film forms a concave or convex surface over each channel. Elongate impedance transformer strips 704 can be located between each channel and placed above the emitter membrane. Each impedance transformer strip can have a width sufficient to enable each side of the strip to extend over a portion of a channel such that there is an opening of a predetermined width between the strips above each channel. The strips can be shaped to provide a rectangular shaped flared opening. The flared opening can have an exponential flare, or some other shape configured to reduce the impedance mismatch between the emitter membrane and the medium in which the film is located. The opening can form an elongated exponential horn which can enable acoustic waves from the emitter membrane to have improved impedance matching with the air surrounding the horn array emitter. The actual dimensions of the opening and shape of the transformer strips can be determined using conventional design considerations. A support 716 can be used to provide added stability to the rectangular emitter 700.

The emitter membrane 710 can be physically displaced to provide periodic displacement waves. The rectangular shape of the emitter can enable the displacement waves to be substantially directional in the long dimension of the emitter, while allowing the waves to spread in the direction perpendicular to the long dimension. When the emitter is used to produce parametric sound, it can be advantageous to provide directionality in only one dimension. For example, when the emitter is used to produce parametric sound in an exhibit such as a museum, the sound can be directed within the confines of a beam of predetermined beam width in the long direction of the speaker. This can confine the sound to be confined to a narrow area of an exhibit room. However, allowing the sound to spread in the narrow dimension of the emitter enables the sound to be heard over a wide variety of heights. This enables confinement of the sound while allowing short and tall exhibit participants to hear the sound substantially equally. Thus, the rectangular shape of the emitter can be beneficial.

An exploded view of the rectangular emitter 700 is shown in FIG. 7b. A first portion 750 is shown comprising the elongate impedance transformer strips 704 coupled to a plurality of supports 716. The transformer strips can be formed using any standard plastic injection or milling process. The strips can be formed from a substantially rigid material such as metal, plastic, composite, or wood. The material from which the strips are formed can be selected for its ability to impedance match the emitter membrane 710 with the surrounding medium (typically air). A second portion 760 is shown comprising the plate 712 used to carry the emitter membrane. The first portion can be coupled to the second portion to form the rectangular emitter.

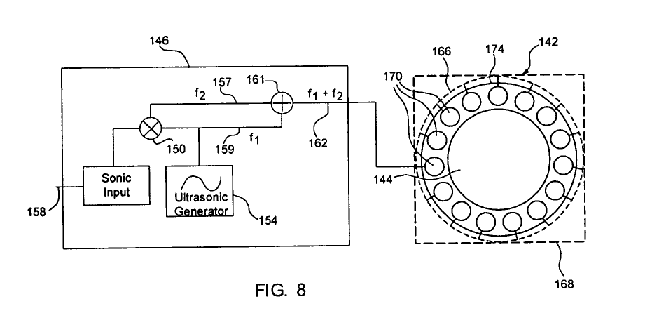

The present invention offers utility in many areas of parametric wave generation. One embodiment of the present invention utilizes a parametric or heterodyning technology, which is particularly adapted for the present thin film structure. The thin electrostatic film of the present invention is well suited for operation at high ultrasonic frequencies in accordance with parametric speaker theory. It is particularly useful in coupling ultrasonic output to surrounding air. The efficiency of this system is most evident with respect to applications with parametric speaker systems where the signal source is coupled to an amplitude modulator for mixing audio frequencies with ultrasonic frequencies to develop an ultrasonic wave form with at least one sideband corresponding to the audio frequencies. The horn array can enable the combined carrier and sideband compression waves to be more efficiently propagated within the surrounding air environment. Due to the non-linear effects of air, the combined carrier and sideband compression wave can produce sum and difference frequencies between the carrier and sideband waves within the air environment. The resulting difference frequencies can comprise the original audio frequencies to generate audio output as part of an acoustic heterodyne speaker system. Such a system is illustrated in FIG. 8.

The parametric speaker 142 includes a typical circuit 146 in which a modulator 150 is coupled to an ultrasonic frequency generator 154 and a sonic (or subsonic) input 158. The sonic or sub-sonic input can include a digital audio source, an analog audio source, a pre-recorded audio source, or a live audio source such as a microphone. The ultrasonic frequency generator 154 can be an oscillator or a digital ultrasonic wave source. The generator can produce a carrier signal, or first ultrasonic signal f₁ 159. The modulator 150 operates to produce a second ultrasonic signal f₂ 157 having a frequency difference from the first ultrasonic signal 159 such that the modulated output, or second ultrasonic frequency f₂ 157, comprises the sum or difference of the sonic input 158 and the first ultrasonic signal f₁ 159. The first and second ultrasonic signals can be combined 161 to produce an ultrasonic parametric signal 162 such that the sonic input 158 can be decoupled from the ultrasonic parametric signal 162 when the parametric signal is produced within a nonlinear medium such as air.

For example, the sonic input 158 can be a 5 kHz sonic signal. The ultrasonic frequency generator 154 can produce a 40 kHz ultrasonic signal as a first ultrasonic signal, f₁ 159. The sonic signal and the first ultrasonic signal 159 can be modulated, or sent through a non-linear circuit such as a mixer 150. The mixer can include a filter to yield a single sideband output of the first ultrasonic signal that is either a sum, 45 kHz, or a difference, 35 kHz, of the first ultrasonic and sonic signals. In this example it will be assumed that the mixer will output the sum, 45 kHz. The output of the single side band mixer f₂ 161 can then be summed 157 with the first ultrasonic signal 159 f₁ to create an ultrasonic parametric signal 162 comprising both the 45 kHz signal output from the mixer and the 40 kHz first ultrasonic signal. The ultrasonic parametric signal 162 can then be emitted by the parametric speaker 142 into a non-linear medium such as air.

At least one embodiment of the present invention is able to function as described because the ultrasonic signals corresponding to f1 and f2 interfere in air according to the principles of acoustical heterodyning. Acoustical heterodyning is somewhat of a mechanical counterpart to the electrical heterodyning effect which takes place in a non-linear circuit. For example, amplitude modulation in an electrical circuit is a heterodyning process. The heterodyne process itself is simply the creation of two new waves. The new waves are the sum and the difference of two fundamental waves.

In acoustical heterodyning, the new waves equaling the sum and difference of the fundamental waves are observed to occur when at least two ultrasonic compression waves interact or interfere in air. The preferred transmission medium of the present invention is air because it is a highly compressible medium that responds non-linearly under different conditions. This non-linearity of air enables the heterodyning process to take place, decoupling the difference signal from the ultrasonic output. However, it should be remembered that any compressible fluid can function as the transmission medium if desired.

In the present example, the non-linear medium of air can cause a sum signal of the 45 kHz signal and the 40 kHz signal to create an 85 kHz signal, and a difference signal of 5 kHz. The 85 kHz signal is well above the human hearing range of 20 kHz and will not be noticed. Thus, the 5 kHz sonic signal is the only frequency which can be heard by a listener.

Whereas successful generation of a parametric difference wave in the prior art appears to have had only nominal volume, the present configuration can generate full sound. This full sound is enhanced to impressive volume levels because of the significant increase in coupling efficiency between the emitter diaphragm and the surrounding air.

The development of full volume capacity in a parametric speaker provides significant advantages over conventional speaker systems. Most important is the fact that sound is reproduced from a relatively massless radiating element. Specifically, there is no radiating element operating within the audio range because the film is vibrating at ultrasonic frequencies. This feature of sound generation by acoustical heterodyning can substantially eliminate distortion effects, most of which are caused by the radiating element of a conventional speaker. For example, adverse harmonics and standing waves on the loudspeaker cone, cone overshoot and cone undershoot are substantially eliminated because the low mass, thin film is traversing distances in millimeters.

It should also be apparent from the description above that the preferred and alternative embodiments can emit sonic frequencies directly, without having to resort to the acoustical heterodyning process described earlier. However, the greatest advantages of the present invention are realized when the invention is used to generate the entire range of audible frequencies indirectly using acoustical heterodyning as explained above.

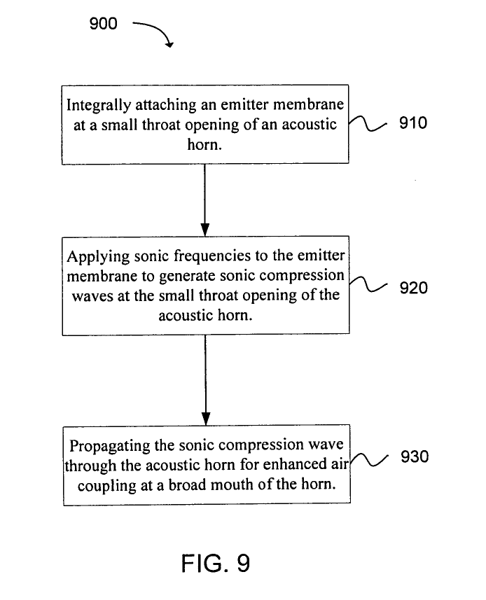

From a procedural perspective, the present invention may be viewed as a method 900 for developing a high efficiency acoustic coupling device for coupling parametric emitters to a surrounding air environment, as shown in the flow chart of FIG. 9. The method can include he steps of: a) integrally attaching an emitter membrane at a small throat opening of an acoustic horn, as shown in block 910; b) applying sonic frequencies to the emitter membrane to generate sonic compression waves at the small throat opening of the acoustic horn, as shown in block 920; and c) propagating the sonic compression wave through the acoustic horn for enhanced air coupling at a broad mouth of the horn, as shown in block 930.

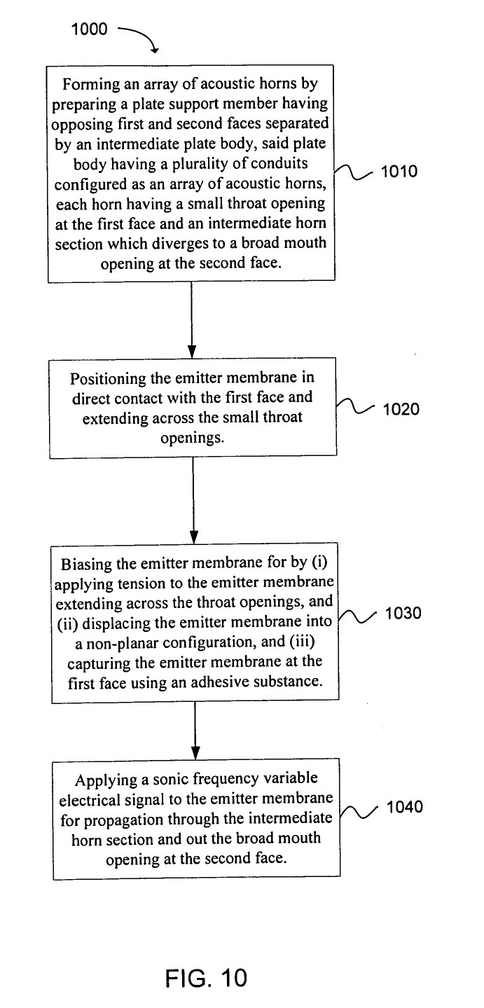

A further embodiment of the present invention includes a method 1000 for developing a high efficiency acoustic coupling device for coupling parametric emitters to a surrounding air environment, as shown in the flow chart of FIG. 10. The method can include the operation of forming an array of acoustic horns by preparing a plate support member having opposing first and second faces separated by an intermediate plate body, said plate body having a plurality of conduits configured as an array of acoustic horns, each horn having a small throat opening at the first face and an intermediate horn section which diverges to a broad mouth opening at the second face, as shown in block 1010. A further operation involves attaching an emitter membrane at a small throat opening of an acoustic horn, as shown in block 1020. Another operation includes biasing the emitter membrane by (i) applying tension to the emitter membrane extending across the throat openings, (ii) displacing the emitter membrane into a non-planar configuration, and (iii) capturing the emitter membrane at the first face using an adhesive substance, as shown in block 1030. A further operation involves applying a variable electrical signal to the emitter membrane for propagation through the intermediate horn section and out the broad mouth opening at the second face, as shown in block 1040.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A parametric emitter array with enhanced emitter-to-air acoustic coupling, said emitter comprising:
a plate support member having opposing first and second faces separated by an intermediate plate body, said plate body having a plurality of conduits configured as an array of acoustic horns, each horn having a small throat opening at the first face and an intermediate horn section which diverges to a broad mouth opening at the second face;
an emitter membrane positioned in direct contact with the first face and extending across the small throat openings;
wherein the emitter membrane is biased by (i) applying tension to the membrane extending across the small throat openings, (ii) displacing the membrane into a non-planar configuration, and (iii) capturing the emitter membrane at the first face using an adhesive substance; and
a variable electrical signal applied to the emitter membrane for propagation of compression waves through the intermediate horn section and out the broad mouth opening at the second face.

2. A parametric emitter array as defined in claim 1, further comprising a back plate positioned behind the emitter membrane and adjacent the small throat openings, said back plate including contact structure for clamping the emitter membrane in fixed position around the small throat opening such that vibrational energy is not transferred through the emitter membrane to adjacent horns.

3. A parametric emitter array as defined in claim 2, wherein the back plate includes protruding structure aligned with each small throat opening, said protruding structure enabling the emitter membrane to be displaced into the non-planar configuration.

4. A parametric emitter array as defined in claim 3, wherein the protruding structure comprises a convex bump having a size approximately equal to the small throat opening, said back plate including means for developing a gap between the convex bump and the emitter membrane to allow vibrational displacement of the emitter membrane when activated with the variable electrical signal without contact with the convex bump.

5. A parametric emitter array as defined in claim 4, wherein the means for developing the gap between the convex bump and the emitter membrane comprises structure for supplying an electrostatic charge operable to repel the emitter membrane from the convex bump during operation.

6. A parametric emitter array as defined in claim 4, wherein the means for developing the gap between the convex bump and the emitter membrane comprises structure for supplying a differential air pressure operable to maintain the gap during operation.

7. A parametric emitter array as defined in claim 4, wherein the means for developing the gap between the convex bump and the emitter membrane comprises structure for supplying a magnetic force operable to repel the emitter membrane from the convex bump during operation.

8. A parametric emitter array as defined in claim 4, wherein the means for developing the gap between the convex bump and the emitter membrane comprises a spacer ring positioned between the emitter membrane and the back plate, said convex bump being disposed in alignment with a central opening of the spacer ring.

9. A parametric emitter array as defined in claim 4, wherein the means for developing the gap between the back plate and the emitter membrane comprises protruding structure having an apex in contact with a central portion of the emitter membrane to physically displace the emitter membrane from the back plate during operation, said contact of the apex with the emitter membrane being sufficiently nominal to allow transfer of the variable electrical signal to the membrane as an emitter.

10. A parametric emitter array as defined in claim 3, wherein the protruding structure comprises a conical structure having an apex in contact with a central portion of the emitter membrane to physically displace the emitter membrane from the back plate during operation, said contact of the apex with the emitter membrane being sufficient to allow transfer of the variable electrical signal to the membrane as an emitter.

11. A parametric emitter array as defined in claim 3, wherein the protruding structure comprises a pin structure having an apex in contact with a central portion of the emitter membrane to physically displace the emitter membrane from the back plate during operation, said contact of the apex with the emitter membrane being sufficient to allow transfer of the variable electrical signal to the membrane as an emitter.

12. A parametric emitter array as defined in claim 1, wherein the emitter membrane is further biased by an electrostatic charge applied to the emitter membrane, the electrostatic charge being configured to displace the emitter membrane from the first face.

13. A parametric emitter array as defined in claim 1, wherein said plate support member is comprised of an electrically conductive material which is capable of carrying a voltage for supplying the variable electrical signal to the emitter membrane.

14. A parametric emitter array as defined in claim 1, wherein the emitter membrane comprises an ESMR film responsive to voltage changes to generate physical vibrations at the small throat opening as an emitter.

15. A parametric emitter array as defined in claim 14, wherein the ESMR film is comprised of a PVDF material.

16. A parametric emitter array as defined in claim 14, wherein the variable electrical signal applied to the emitter membrane comprises a voltage signal source coupled to the emitter membrane and operable to supply the variable electrical signal which is converted by the ESMR film of the emitter membrane into the compression waves.

17. A parametric emitter array as defined in claim 16, wherein the voltage signal source comprises an ultrasonic signal generator which is coupled to an amplitude modulator for mixing audio frequencies with ultrasonic frequencies to develop an ultrasonic wave form having at least one sideband corresponding to the audio frequencies, said sonic emitter providing ultrasonic compression waves propagating from the horn array within a surrounding air environment which decouples the audio frequencies to generate audio output as part of an acoustic heterodyne speaker system.

18. A parametric emitter array as defined in claim 2, wherein the emitter membrane comprises a dielectric material responsive to electrostatic voltage changes to generate physical vibrations at the small throat opening as an electrostatic sonic emitter, said back plate comprising a conductive medium capable of driving the electrostatic emitter at the sonic frequencies.

19. A parametric emitter array as defined in claim 18, wherein the variable electrical signal applied to the emitter membrane comprises a voltage signal source coupled to the back plate and operable to supply a variable signal which is converted by the dielectric material of the emitter membrane into the compression waves.

20. A parametric emitter array as defined in claim 19, wherein the variable electrical signal comprises an ultrasonic signal generator which is coupled to an amplitude modulator for mixing audio frequencies with ultrasonic frequencies to develop an ultrasonic wave form having at least one sideband corresponding to the audio frequencies, said parametric emitter providing ultrasonic compression waves propagating from the horn array within a surrounding air environment which decouples the audio frequencies to generate audio output as part of an acoustic heterodyne speaker system.

21. A parametric emitter array as defined in claim 1, wherein the plate support member comprises a circular plate.

22. A parametric emitter array as defined in claim 1, wherein plate support member includes an emitter array having a diameter of at least three inches.

23. A parametric emitter array as defined in claim 21, wherein the circular plate is planar in configuration.

24. A parametric emitter array as defined in claim 21, wherein the circular plate is concave in configuration, having a radius of curvature selected to minimize phase misalignment at a listener location at a predetermined distance from the emitter array.

25. A parametric emitter array as defined in claim 1, wherein the array of horns comprises conduits which are molded to a desired shape within the plate support member for acoustic coupling of ultrasonic frequencies to surrounding air.

26. A parametric emitter array as defined in claim 1, wherein the array of horns comprises conduits which are machined to a desired shape within the plate support member for acoustic coupling of ultrasonic frequencies to surrounding air.

27. A parametric emitter array as defined in claim 1, wherein the emitter membrane is preformed with an array of dimples positioned for alignment with the small throat openings of the horn array to provide the non-planar configuration.

28. A parametric emitter array as defined in claim 27, wherein the array of dimples are uniform in size and acoustic response to generate a substantially common wave front at the second face of the plate support member.

29. A parametric emitter array as defined in claim 1, wherein the adhesive substance is applied to the emitter membrane to enable the emitter membrane to be captured at the first face.

30. A parametric emitter array as defined in claim 1, wherein the adhesive substance is applied to the emitter membrane to form a substantially uniform layer of adhesive on the emitter membrane by applying the adhesive to the emitter membrane using a screen printing technique.

31. A parametric emitter array as defined in claim 30, wherein the substantially uniform layer of adhesive on the emitter membrane has an average thickness of less than less than ten thousandths of an inch.

32. A parametric emitter array as defined in claim 1, wherein the variable electrical signal varies at one of an ultrasonic frequency and a sonic frequency.

33. A parametric emitter array as defined in claim 1, wherein the variable electrical signal varies at two or more frequencies.

34. A parametric emitter array as defined in claim 1, wherein the array of acoustic horns further comprises a plurality of elongate impedance transformer strips configured to reduce an impedance mismatch between the emitter membrane and the air.

35. A parametric emitter array as defined in claim 34, further comprising a plate having a plurality of substantially parallel channels.

36. A parametric emitter array as defined in claim 35, wherein the emitter membrane is coupled to the plate support member over the parallel channels.

37. A parametric emitter array as defined in claim 36, wherein the emitter membrane is coupled to the plate support member in such a way that the emitter membrane forms one of a concave and a convex surface over at least one channel.

38. A parametric emitter array as defined in claim 34, wherein at least one of the plurality of elongate impedance transformer strips is configured to provide a rectangular shaped exponential opening adjacent to the parallel channels.

39. A parametric emitter array as defined in claim 34, wherein the plurality of elongate impedance transformer strips have a length sufficient to enable the parametric emitter array to have a rectangular shape, wherein the rectangular shaped parametric emitter array enables directional sound to be produced in one dimension of the array.

40. A method for developing a high efficiency acoustic coupling device for coupling parametric emitters to a surrounding air environment, said method comprising the steps of:
a) attaching an emitter membrane at a small throat opening of an acoustic horn;
b) applying a variable electrical signal to the emitter membrane to generate compression waves at the small throat opening of the acoustic horn; and
c) propagating the compression waves through the acoustic horn for enhanced air coupling at a broad mouth of the horn.

41. A method as defined in claim 40, further comprising the steps of:
forming an array of acoustic horns by preparing a plate support member having opposing first and second faces separated by an intermediate plate body, said plate body having a plurality of conduits configured as an array of acoustic horns, each horn having a small throat opening at the first face and an intermediate horn section which diverges to a broad mouth opening at the second face;
positioning an emitter membrane in direct contact with the first face and extending across the small throat openings;
biasing the emitter membrane by (i) applying tension to the emitter membrane extending across the small throat openings, (ii) displacing the emitter membrane into a non-planar configuration, and (iii) capturing the emitter membrane at the first face using an adhesive substance; and
applying a variable electrical signal to the emitter membrane for propagation through the intermediate horn section and out the broad mouth opening at the second face.

42. A method as defined in claim 41, wherein the biasing step is accomplished in part by coupling a back plate against the emitter membrane to pinch the emitter membrane at the small throat opening and isolating the emitter membrane from adjacent acoustic horns within the plate support member.

43. A method as defined in claim 41, wherein the emitter membrane performs the additional step of actively generating compression waves within the acoustic horn.

44. A parametric emitter array with enhanced emitter-to-air acoustic coupling, said emitter comprising:
a plate support member having opposing first and second faces, the first face having a plurality of substantially parallel channels;
an emitter membrane coupled to the first side of the plate support member over the plurality of substantially parallel channels; and
at least two elongate impedance transformer strip configured to provide a rectangular shaped flared opening adjacent to the parallel channels.

45. A parametric emitter array as defined in claim 44, wherein the emitter membrane is biased by (i) applying tension to the membrane extending across the plurality of channels, (ii) displacing the membrane into a non-planar configuration, and (iii) capturing the emitter membrane at the first face using an adhesive substance.

46. A parametric emitter array as defined in claim 45, wherein the adhesive substance is applied to the emitter membrane to form a substantially uniform layer of adhesive on the emitter membrane by applying the adhesive to the emitter membrane using a screen printing technique.

47. A parametric emitter array as defined in claim 45, wherein the adhesive substance is applied to the emitter membrane in a layer having an average thickness of less than ten thousandths of an inch.

48. A parametric emitter array as defined in claim 44, further comprising a variable electrical signal applied to the emitter membrane for propagation of compression waves through the intermediate horn section and out the broad mouth opening at the second face.

49. A parametric emitter array as defined in claim 44, wherein the emitter membrane is coupled to the plate support member in such a way that the film forms one of a concave and a convex surface over at least one channel.

50. A parametric emitter array as defined in claim 44, wherein the emitter array has a first dimension that is longer than a second dimension to enable the emitter array to emit compression waves that are more directional in the first dimension compared to the second dimension.
